(19) United States
(12) Patent Application Publication
(10) Pub. No.: US 2004/0066335 A1
(43) Pub. Date: Apr. 8, 2004

(54) Moving antenna phase array systems related to multipath signals in global positioning applications, and methods of using

(76) Inventor: Javad Ashjaee, Saratoga, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/428,978

(22) Filed: May 2, 2003

Related U.S. Application Data
(60) Provisional application No. 60/377,869, filed on May 2, 2002.

(51) Int. Cl. H01Q 1/38; H01Q 1/48

(52) U.S. Cl. 343/700 MS; 343/846

(57) ABSTRACT

Antenna systems and methods are disclosed for receiving the signals of navigation satellites, such as global positioning satellites. The systems may be useful in reducing the effects of multipath signals on global positioning satellite signals.

### CROSS-REFERENCE TO RELATED APPLICATION

This application claims priority under 35 U.S.C. § 119(e) to Provisional U.S. Patent Application Serial No. 60/377,869, filed May 2, 2002, the entire contents of which are incorporated herein by reference.

### FIELD OF THE INVENTION

The present invention relates to antennas for receiving the signals of navigation satellites and which may be useful in reducing the effects of multipath signals, and methods of using such antennas. More particularly, the present invention relates to antennas and methods of use thereof for global positioning applications.

### BACKGROUND OF THE INVENTION

There is a need in the global positioning (GP) art to reduce the effects of multipath signals on the tracking of global positioning satellite (GPS) signals.

### SUMMARY OF THE INVENTION

Broadly stated, the present invention encompasses antenna systems and methods which receive one or more global positioning satellite signals at an antenna element which is moved through a plurality of positions relative to a reference point while receiving the satellite signal(s). The antenna element is preferably moved along a vector which is substantially fixed with respect to the reference point. The antenna element may be disposed over a ground plane and moved with respect to a reference point on the ground plane, or the antenna element may be disposed about a housing and moved relative to a reference point on the housing. In the latter embodiment, the antenna element may be mounted on a ground plane. The antenna element is preferably moved along a range which is one-half or less of a wavelength of the carrier signal of the received satellite signal, and more preferably along a range which is within ⅛ wavelength to 3/8 wavelengths (e.g., substantially about ¼ of a wavelength).

The present invention may be used to emulate a phase array antenna without some of the disadvantages of a phase array antenna (e.g., the need for multiple antenna elements). As one example, the position of the antenna may be determined by a position sensor or from command signals to a servo-motor, and the positioning information in the satellite signal may be correlated to the position of the antenna at the instances that the positioning information of satellite signal is sampled. The correlation of antenna position with the satellite information at selected instances of time enables one to view these instances of time as though they were instances of data from a phase array antenna. These instances of data may then be used to compute the position of a second reference point in a manner which may be able to reduce the effects of any multipath signals received by the antenna element. The second reference point may be the same as the first reference point, but may be different, in which case is it preferably in a fixed relationship to the first reference point.

Accordingly, it is an object of the present invention to provide methods and antenna systems which can receive the satellite signals from navigation satellites and the like.

It is a further object of the present invention to provide methods and antenna systems which may be of use in reducing the effects of multipath signals on the computation of global positioning coordinates.

These and other objects of the present invention will become apparent to those skilled in the art from the following detailed description of the invention, the accompanying drawings, and the appended claims.

### BRIEF DESCRIPTION OF THE DRAWINGS

FIG. 1 shows a first exemplary antenna system according to the present invention.

FIG. 2 shows a second exemplary antenna system according to the present invention.

FIG. 3 shows a third exemplary antenna system according to the present invention.

FIG. 4 shows a fourth exemplary antenna system according to the present invention.

### DETAILED DESCRIPTION OF THE INVENTION

As part of making his invention, the inventor has recognized that multipath signals have different signatures on the tracking of the satellite signals depending upon the height of the antenna. The inventor has further recognized that the effects of the multipath signal can, in theory, be averaged to a value near zero by taking several measurements while moving the antenna through different heights, preferably within a range of about a quarter of a wavelength to one wavelength of the carrier frequency.

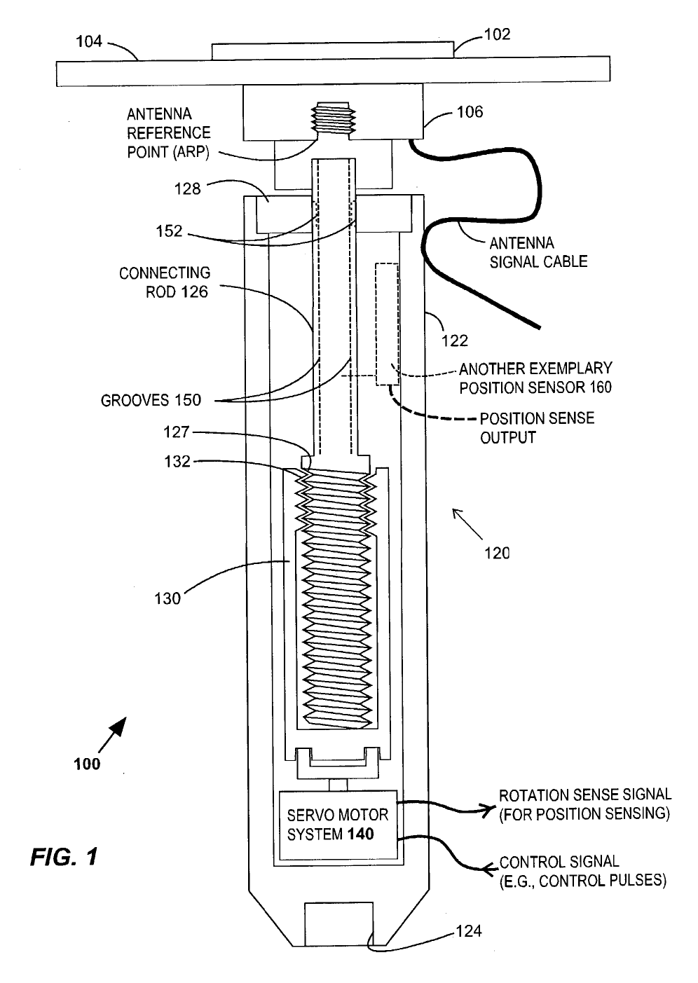

The exemplary antenna systems 100, 200, 300 and 400 shown in FIGS. 1-4, and variations thereof, may be used.

Referring to FIG. 1, the antenna system 100 comprises an antenna element 102 mounted on a ground plane 104, which has a mounting pedestal 106 on the back side of the ground plane 104, opposite to the antenna element 102. The antenna element 102 may comprise any type of antenna used for global positioning applications (e.g., patch antenna, crossed-dipole antenna, etc.). As an option, a low-noise amplifier may be incorporated into the pedestal or ground plane.

Normally, a range pole (not shown) would be coupled to the mounting pedestal 106 (at the antenna reference point). Instead, in the embodiment of the present invention shown in FIG. 1, a variable translation unit 120 is coupled between the mounting pedestal and the range pole. The translation unit comprises a housing 122, a socket 124 at the bottom of the housing that is adapted to be coupled to a range pole, a connecting rod 126 disposed within the housing 122, and a sleeve bearing 128 at the top of the housing through which the connecting rod 126 moves. The connecting rod has a first distal end that is adapted to be coupled to the pedestal 106 at the antenna reference point, and a second distal end which is moved by a servo-motor system 140, which is described below in greater detail. The translation unit 120 moves the connecting rod 126 up and down within the housing 122, and thus moves the antenna element 102 up and down. The translation unit is responsive to control pulses to move it in some accurate steps. The connecting rod and antenna element are thereby moved within a range of positions disposed along a vector which is fixed to all points on the housing. The translation unit 120 also preferably provides a signal representative of the height position of the first distal end of the connecting rod. This signal enables one to factor out the variation in measurements of the satellite signals due to the motion of the antenna, thereby providing one the opportunity to average the effects of the multipath signals. In the embodiment shown in FIG. 1, the connecting rod 126 has a threaded end at its second distal end, and is moved up and down by a sleeve tube 130 which is driven by a servo motor system 140. The sleeve tube 130 comprises a thread 132 disposed within its interior, at least at the top end of the sleeve tube, with the thread interfitting and being complementary to the thread 127 on the second distal end of the connecting rod 126. The servo motor system 140 rotates the sleeve tube 130 about the central axis of the sleeve tube. This motion causes the thread 132 of the sleeve tube to traverse across the threads 127 of the connecting rod 126, causing the connecting rod 126 to go up or down, depending upon the rotation direction of the sleeve tube 130. To prevent the connecting rod from rotating during the rotation of the sleeve tube, one or more grooves 150 are formed axially along the surface of the connecting rod 126 near the first distal end, and a key 152 is interfit into the groove and the housing to prevent rotation.

To determine the height of antenna element 102 relative to a point on the housing 122, or to determine the height of the connecting rod 126 (as for example measured at the antenna reference point ARP) relative to the top of the housing, the servo motor system 140 may include a rotation counter, and/or a rotational phase sensor, which provide an output signal (e.g., “rotation sense signal”as shown in FIG. 1). Given the pitch of the threads, one can easily derive a relationship between the height of the ARP and the number rotations that the servo motor goes through from any given reference point (such a reference point may be when the connecting rod is fully retracted in the housing). As another implementation, the translation unit may comprise a servo stepping motor which moves the connecting rod in steps of predictable amounts in response to electrical control pulses provided to the motor by a controller. The controller usually also provides the stepping servo motor a direction signal which tells the motor which direction to move the connecting rod and antenna. The height of the antenna relative to the top of housing 122 can then be determined by the number of control pulses (and direction) that the controller sends to the stepping servo motor. As yet another option, a linear position sensor 160 (shown in dashed outline) may be disposed within housing 122 and may have a mechanical input arm coupled to the connecting rod 126. Instead of a mechanical arm, an optical sensing link between sensor 160 and a point on connecting rod 126 may be used.

The housing, connecting rod, and sleeve tube can all be manufactured from light weight plastic parts.

An antenna signal cable (as shown in FIG. 1) may be routed from antenna element 102 through pedestal 106 to the outside. From here, a part of the signal cable may be anchored to housing 122, with a large loop of cable being present between housing 122 and pedestal 106 to allow relative movement between housing 122 and pedestal 106.

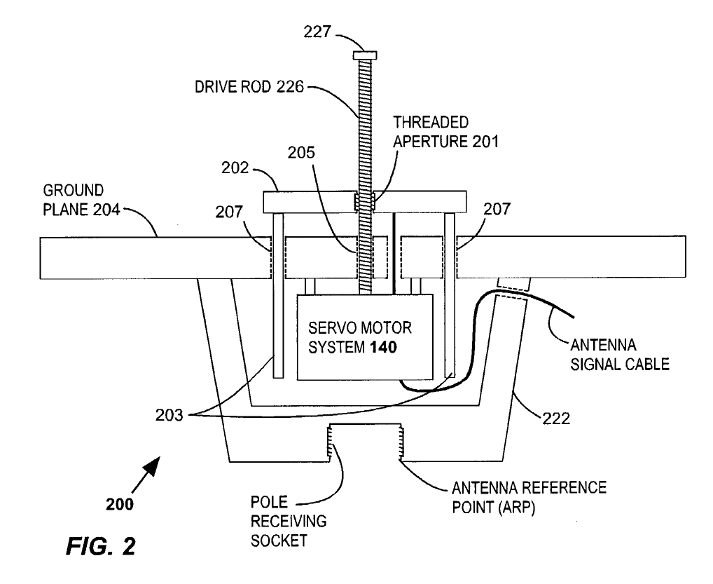

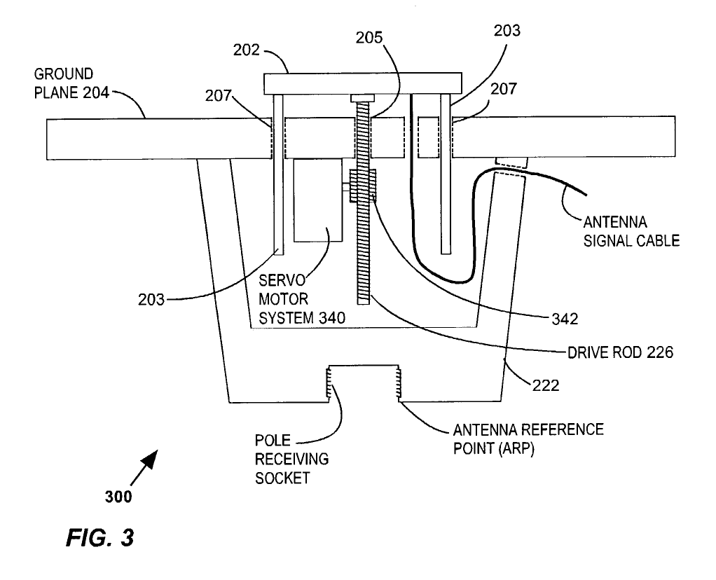

FIGS. 2 and 3 show second and third exemplary antenna systems, respectively, according to the present invention. In these embodiments, an antenna element 202 is moved up and down over a ground plane 204. Referring to FIG. 2, the ground plane 204 comprises an aperture 205 through which a drive rod 226 is disposed. The rod 226 is able to move within the aperture 205 and is capable of moving the antenna element 202. The rod 226 comprises a circular thread disposed on the rod's surface along the rod's axial direction, and the antenna element 202 comprises a threaded aperture 201 which interfits with the thread of the rod 226. A servo motor system 140 rotates the rod, which in turn causes the rod to move the antenna element in an up-and-down manner. The servo motor system 140 may be substantially the same as that shown in FIG. 1, where the control signal and rotation sense signal have not been shown in FIG. 2 (but are present in FIG. 1) to simplify the visual complexity of FIG. 2. The Servo motor system 140 is preferably mounted below the ground plane 204, but may be mounted above it. A low noise amplifier (LNA) may be mounted to the underside of the antenna element 202, and a flexible cable from the LNA or the antenna element (as shown in FIG. 2) may be routed through another aperture in ground plane 204, and into housing 222 disposed under ground plane 204, with a loop of cable slack present within a housing 222. To prevent the antenna element 202 from rotating while the rod 226 is being rotated, one or more guides 203 may be mechanically attached to the underside of the antenna element 202 and feed through corresponding apertures 207 in the ground plane 204.

The connecting rod 226 may be made of metal or plastic. In either case, the rod is expected to have minimal impact on the antenna's reception pattern when it is mounted at or near the center of the antenna element. In addition, any effects that the rod has may be reduced by the average of the data that is used in an effort to reduce the impacts of the multipath signals. As an option, a stop tab 227 may be added to the end of drive rod 226 to prevent over-travel.

FIG. 3 shows an embodiment 300 where the aperture 201 in the antenna element 202 is not used. System 300 uses many of the same elements as system 200, with the common elements being identified by common reference numbers, which have been previously described. In this case, the antenna element 202 rests on top of the connecting drive rod 226, which is moved up and down by a wheel-shaped drive thread 342, which in turn is driven by a servo motor 340. In this embodiment, the threads on the rod may be circular or linear (the latter being an array of separately spaced grooves).

In both of the embodiments shown in FIGS. 2 and 3, the housing is disposed below the ground plane and has a pole receiving socket.

It may be appreciated that other mechanisms, such as linear actuators, may be used to move the antenna element.

In all of the embodiments of the present invention, stepper servo-motors may be used to determine the height of the antenna element relative to a fixed point indirectly and inherently by counting the number of control pulses sent to the servo motor, or directly by using servo-motors which have rotational counters and/or sensors. Also, independent position sensors may be used.

In one exemplary use of the present invention, the antenna is moved up and down by the rod while the satellite signals are measured at a plurality of time moments (e.g., epochs) to create a plurality of data sets at different times and different positions of the rod. This is similar to a phase array antenna, but in this case one antenna is moved to different locations to measure different phases. Then the measurements at different phases are processed to estimate a position location for the antenna element.

In another exemplary use of the present invention useful for stationary applications, the position location of the antenna element may be estimated without the use of the antenna position information from the servo-motor system or a separate position sensor. In this example, the motion of the antenna and the sampling of the satellite information are done such that mean position of the sampled data corresponds to a predetermined spot that is fixed in relation to the housing. It is believed that the averaging process previously described above will average the satellite data to this mean position. As one example of achieving this, the antenna may be moved in a periodic motion and the data from the satellites sampled at equal intervals of time.

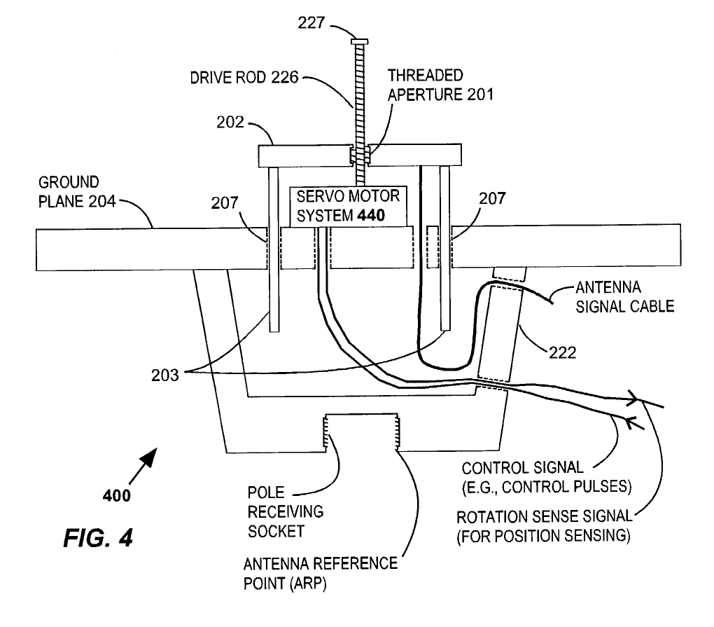

As previously indicated above, the servo-motor system may be mounted above the ground plane 204. This is exemplified by antenna system 400 shown in FIG. 4, where a servo motor system 440 is mounted above ground plane 204 and below antenna element 202. Antenna system 400 uses many of the same elements as system 200, with the common elements being identified by the common reference numbers, which have been previously described. Servo system 440 may be substantially the same as servo systems 140 and 340, and is preferably of a low height profile.

While the present invention has been particularly described with respect to the illustrated embodiments, it will be appreciated that various alterations, modifications and adaptations may be made based on the present disclosure, and are intended to be within the scope of the present invention. While the invention has been described in connection with what is presently considered to be the most practical and preferred embodiments, it is to be understood that the present invention is not limited to the disclosed embodiments but, on the contrary, is intended to cover various modifications and equivalent arrangements included within the scope of the appended claims.

What is claimed is:

1. An antenna system comprising:
a reference point;
an antenna element; and
a positioning unit disposed between the reference point and the antenna element which moves the antenna element through a plurality of positions.

2. The antenna system of claim 1 wherein the antenna element is moved along a vector which is substantially fixed with respect to the reference point.

3. The antenna system of claim 2 wherein the satellite signal received by the antenna element has a wavelength, and wherein the antenna element is moved over a range of one-half wavelength or less along the vector.

4. The antenna system of claim 2 wherein the satellite signal received by the antenna element has a wavelength, and wherein the antenna element is moved over a range of one-fourth wavelength or less along the vector.

5. The antenna system of claim 2 wherein the satellite signal received by the antenna element has a wavelength, and wherein the antenna element is moved over a range of three-eighths wavelength or less along the vector.

6. The antenna system of claim 1 further comprising a ground plane, wherein the antenna element is disposed above the ground plane, and wherein the reference point is located on the ground plane.

7. The antenna system of claim 1 further comprising a housing, wherein the antenna element is disposed above the housing, and wherein the reference point is located on the housing.

8. The antenna system of claim 1 further comprising a sensor that measures the position of the antenna element relative to the reference point without the use of information conveyed by the satellite signal.

9. The antenna system of claim 1 further comprising a servo-motor mechanically coupled to the antenna element, and wherein the position of the antenna element is inferred from control signals sent to the servo motor.

10. An antenna system comprising:
a ground plane;
an antenna element mounted on the ground plane;
a housing having a bottom and a top; and
a connecting rod disposed within the housing and having a first end moveably extending from the top of the housing, the first end being mechanically coupled to the ground plane.

11. The antenna system of claim 10 wherein the connecting rod further comprises a second end disposed within the housing, and wherein the antenna system further comprises a positioning unit mechanically coupled to the rod's second end which is capable of moving the rod's second end through a plurality of positions.

12. The antenna system of claim 11 wherein the second end of the connecting rod comprises a first thread, and wherein the positioning unit comprises a threaded member with a second thread coupling to the first thread and a servo motor driving the threaded member.

13. An antenna system comprising:
a ground plane having a top surface, an bottom surface, and a first aperture formed through the ground plane between the top and bottom surfaces;
an antenna element located above the top surface of the ground plane; and
a rod disposed through the first aperture of the ground plane and moveably extending therethrough, the rod being capable of moving the antenna element.

14. The antenna system of claim 13 wherein the rod comprises a circular thread disposed on the rod's surface along the rod's axial direction; and wherein the antenna element comprises a threaded aperture which interfits with the thread of the rod.

15. The antenna system of claim 14 further comprising a motor which rotates the rod.

16. The antenna system of claim 15 wherein the motor is disposed below the ground plane.

17. The antenna system of claim 15 wherein the motor is disposed above the ground plane.

18. The antenna system of claim 13 wherein the rod comprises a thread disposed on the rod's surface along the rod's axial direction; and wherein the antenna system further comprises a drive element which interfits with the rod's thread.

19. The antenna system of claim 18 wherein the drive element comprises a wheel with a thread disposed on a surface thereof, and wherein the antenna system further comprises a motor which drive the wheel.

20. The antenna system of claim 19 wherein the motor is disposed below the ground plane.

21. The antenna system of claim 13 further comprising a guide which limits the rotational motion of the antenna element.

22. The antenna system of claim 21 wherein the ground plane further comprises a second aperture, and wherein the guide is mechanically attached to the antenna element and is disposed within the second aperture of the ground plane in order to move up and down within the second aperture.

23. The antenna system of claim 13 further comprising a housing disposed at the bottom surface of the ground plane, the housing comprising a pole receiving socket.

24. A method of receiving a global positioning satellite signals at an antenna element comprising moving the antenna through a plurality of positions relative to a reference point while receiving the satellite signal.

25. The method of claim 24 wherein the antenna element is moved along a vector which is substantially fixed with respect to the reference point.

26. The method of claim 25 wherein the satellite signal received by the antenna element has a wavelength, and wherein the antenna element is moved over a range of one-half wavelength or less along the vector.

27. The method of claim 25 wherein the satellite signal received by the antenna element has a wavelength, and wherein the antenna element is moved over a range of one-fourth wavelength or less along the vector.

28. The method of claim 24 wherein the antenna element is disposed above a ground plane, and wherein the reference point is located on the ground plane.

29. The method of claim 24 wherein the antenna element is disposed above a housing, and wherein the reference point is located on the housing.

30. The method of claim 24 further comprising the step of determining the position of the antenna element relative to the reference point without the use of information conveyed by the satellite signal.
